(19) United States
(12) Patent Application Publication
(10) Pub. No.: US 2025/0293473 A1
(43) Pub. Date: Sep. 18, 2025

(54) PLUG ADAPTER WITH FOLDABLE PINS

(71) Applicant: Anker Innovations Technology Co., Ltd., Changsha (CN)

(72) Inventors: Qingqing Wu, Shenzhen (CN); Xianjie Tang, Shenzhen (CN); Tao Chen, Shenzhen (CN)

(21) Appl. No.: 19/076,016

(22) Filed: Mar. 11, 2025

(30) Foreign Application Priority Data
Mar. 12, 2024 (CN) 202420482556.8

(51) Int. Cl. H01R 31/06; H01R 13/04; H01R 13/42; H01R 13/506; H01R 13/66

(52) U.S. Cl. CPC H01R 31/065; H01R 13/04; H01R 13/42; H01R 13/506; H01R 13/6658

(57) ABSTRACT

A plug comprises a housing having an accommodating chamber, an opening in communication with the accommodating chamber, and an adapter hole. The plug further comprises a lifting platform configured to slide in an axial direction of the opening relative to the housing, and a plurality of pins pivotably connected to the lifting platform and configured to switch between an unfolded position and a stored position. The plurality of pins can be folded in storage grooves of the lifting platform and/or the housing, and can extend along the axial direction of the opening in the unfolded position.

### CROSS-REFERENCE OF RELATED APPLICATION

The present application claims priority to CN202420482556.8, filed on Mar. 12, 2024, which is incorporated by reference by its entirety.

### FIELD

The present disclosure relates to the technical field of plug adapters, in particular to a plug.

### BACKGROUND

When traveling across countries, people often encounter situations where a plug of electric equipment carried does not match a local socket, and in order to meet user needs during multi-country travel, a plug adapter for a power source is required to resolve this issue. By integrating pins of multiple countries into a single plug adapter, a user can insert desired pins into a target, thus effectively breaking down power supply barriers between different pins and jacks. In the related art, a European-standard travel charger plug adapter generally includes pins mounted on a mount which is then attached to a plug. Such a design results in a large storage space required for a product main body and thus a large overall volume of the product.

### SUMMARY

The present disclosure provides a plug which can shorten a sinking depth of pins when the pins are stored and reduce a storage volume of the pins, making a housing of the plug lighter and thinner.

The present disclosure provides a plug comprising: a housing having an accommodating chamber, and provided with an opening in communication with the accommodating chamber and an adapter hole for insertion of another plug; and a lifting platform that is configured to slide in an axial direction of the opening relative to the housing, so as to enter and exit the accommodating chamber through the opening. The plug further comprises a plurality of pins that are rotatably connected to the lifting platform, so as to switch between an unfolded position and a stored position.

The housing and/or the lifting platform is provided with storage grooves configured to store the plurality of pins when the plurality of pins are at the stored position. When the plurality of pins are at the unfolded position, the plurality of pins extend along the axial direction of the opening, and an end of each of the plurality of pins is located outside the storage groove.

The present disclosure have the following beneficial effects: a plurality of pins can be folded and stored in the storage grooves of the lifting platform and/or the housing, and the lifting platform can slide along the axial direction of the opening so as to be stored in the accommodating chamber of the housing, thereby shortening a depth (e.g., a length) of the plurality of pins and the lifting platform sinking into the housing to make the plug lighter and thinner and easy to be carried.

### BRIEF DESCRIPTION OF DRAWINGS

In order to more clearly illustrate technical solutions in the present disclosure or the related art, drawings that need to be used in description of the examples or the related art are briefly introduced below, and it will be apparent in to those of ordinary skill in the art that the drawings in the following description are only some examples of the disclosure, and other drawings can be obtained in accordance with these drawings without inventive work.

FIG. 1 is a schematic view showing a structure of a plug in an example of the present disclosure;

FIG. 2 is a schematic view showing a structure of a plug from a first viewing angle in another example of the present disclosure;

FIG. 3 is a schematic view showing a structure of a plug from a second viewing angle in another example of the present disclosure;

FIG. 4 is a schematic view showing a partial structure of a plug in another example of the present disclosure;

FIG. 5 is a schematic view showing a partial structure of a plug in still another example of the present disclosure;

FIG. 6 is a schematic view showing an exploded structure of a part of a plug in an example of the present disclosure;

FIG. 7 is a schematic view showing a structure of a first pin assembly in an example of the present disclosure;

FIG. 8 is a schematic view showing a structure of a limiting bracket in an example of the present disclosure;

FIG. 9 is a schematic view showing a structure of a locking member and a lifting platform in an example of the present disclosure;

FIG. 10 is a schematic view showing a structure of a locking member, a limiting bracket and a lifting platform in an example of the present disclosure;

FIG. 11 is a schematic view showing a structure of a limiting bracket and a part of a second pin assembly in an example of the present disclosure;

FIG. 12 is a schematic view showing a structure of a plug in an example of the present disclosure;

FIG. 13 is a schematic view showing a structure of a plug in an example of the present disclosure;

FIG. 14 is a schematic view showing a structure of a limiting structure from a first viewing angle in an example of the present disclosure;

FIG. 15 is a schematic view showing a structure of a limiting structure from a second viewing angle in an example of the present disclosure; and

FIG. 16 is a schematic view showing a cross-sectional structure of a limiting structure and a lifting platform in an example of the present disclosure.

### REFERENCE NUMERALS

1: plug; L1: first direction; L2: second direction; 10: housing; 11: opening; 12: adapter hole; 13: storage groove; 14: limiting bracket; 141: limiting portion; 142: sliding portion; 20: lifting platform; 21: conductive member; 211: sandwich slot; 22: limiting groove; 221: bevel groove wall; 23: base; 24: main body; 30: first pin assembly; 31: first pin; 311: power connection portion; 32: rotating shaft; 321: abutting plane; 322: protrusion; 33: conductive electrode; 42: locking member; 421: clamping portion; 43: elastic member; 50: second pin assembly; 51: second pin; 511: UK-standard pin; 512: US-standard pin; 513: Chinese-standard pin; 52: bearing plate; 521: fixing portion; 522: sliding block; 53: button; 531: button main body; 532: lock catch; 533: spring; 534: sliding groove; 60: limiting structure; 61: first portion; 612: first region; 613: first bevel; 614: second bevel; 62: second portion; 622: second region; 623: third region; 624: fourth region; 625: third bevel; 63: elastic arm; 70: jack module.

### DETAILED DESCRIPTION

In order to more clearly illustrate the technical solutions in the present disclosure or the related art, clear and full description will be made below with reference to the accompanying drawings in the present disclosure. Obviously, the examples to be described are merely part of the disclosure, but not all of the disclosure. Based on the examples of the present disclosure, all other examples obtained by those of ordinary skill in the art without inventive work shall fall within the scope of the disclosure.

In the related art, a European-standard travel charger plug adapter generally includes a plug main body, a mount, and pins. The pins are mounted on the mount which is then attached to the plug main body. Such a design results in a large occupancy volume of the mount and the pins and a large thickness and a large overall volume of the plug.

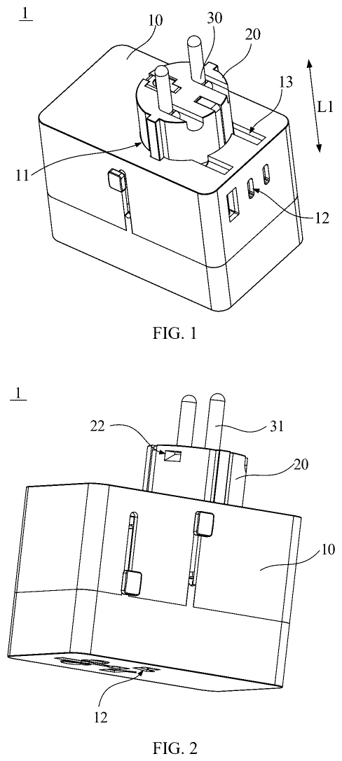

In view of the above problem, referring to FIGS. 1 to 4, the present disclosure describes a plug 1 including a housing 10, a lifting platform 20 (e.g., a body), and a first pin assembly 30.

The housing 10 has an accommodating chamber and is provided with an opening 11 in communication with the accommodating chamber and an adapter hole 12 for insertion of another plug. When a plug of electric equipment carried by a user cannot match a local socket, the plug of the electric equipment can be inserted into the adapter hole 12, realizing a power supply function. The adapter hole 12 may be of various types such as a USB jack, Chinese-standard double jacks or Chinese-standard triple jacks.

The lifting platform 20 is disposed on the housing 10 and can move (e.g., slide) in an axial direction of the opening 11 relative to the housing 10 so as to enter and exit the accommodating chamber through the opening 11. The lifting platform 20 may at least partially extend above a surface of the housing 10. The lifting platform 20 may be a cover or storage for pins (e.g., prongs). The first pin assembly 30 is disposed on the lifting platform 20 and includes a plurality of first pins 31 which are rotatably connected to the lifting platform 20 to switch between an unfolded position and a stored position (e.g., a folded position). For example, the first pin assembly 30 includes two first pins 31 to form a two-pin plug, and the two first pins 31 are respectively configured to be connected to a live wire and a neutral wire. Alternatively, the first pin assembly 30 includes three first pins 31 to form a three-pin plug, and the three first pins 31 are respectively configured to be connected to a live wire, a neutral wire, and a ground wire.

When the plug 1 in the present example is used, the lifting platform 20 may be pushed out of the accommodating chamber first, and then the first pins 31 are rotated to a state of extending along the axial direction of the opening 11. Thus, the plug is inserted into the socket for normal power supply, and the lifting platform 20 and the first pin assembly 30 may together form European-standard pins.

For example, the housing 10 is provided with storage grooves 13 in one-to-one correspondence with a plurality of the first pins 31, and a plurality of the first pins 31 can be stored in the storage grooves 13. Alternatively, the storage grooves 13 are provided in the lifting platform 20. Also or alternatively, both the housing 10 and the lifting platform 20 are provided with grooves. When the lifting platform 20 enters the accommodating chamber, the groove in the lifting platform 20 is aligned with the groove in the housing 10 to form the complete storage groove 13, and thus the first pins 31 are completely stored in the storage grooves 13. The storage grooves 13 are used to store the first pins 31 when the first pins 31 are at the stored position, and when the first pins 31 are at the unfolded position, the first pins 31 extend along the axial direction of the opening 11, and a head end (e.g., an end) of the first pin 31 is located outside the storage groove 13.

It should be noted that a plurality of the first pins 31 are folded and stored in the storage grooves 13 of the lifting platform 20 and/or the housing 10, the lifting platform 20 is stored in the accommodating chamber of the housing 10 by sliding along the axial direction of the opening 11, thereby shortening a depth (e.g., thickness) of the first pin assembly 30 and the lifting platform 20 sinking into the housing 10, so as to make the plug 1 lighter and thinner and easy to be carried.

In some examples, the first pin assembly 30 includes a conductive electrode 33 and two first pins 31, and the two first pins 31, the conductive electrode 33 and the lifting platform 20 together form a three-pin European-standard plug. In the related art, most of European-standard plug adapters are lower-power two-pin European-standard plugs, which limits power supply at high power when using power; but in the example of the present disclosure, the two first pins 31, the conductive electrode 33, and the lifting platform 20 together form a three-pin European-standard plug, which is convenient to supply power at high power.

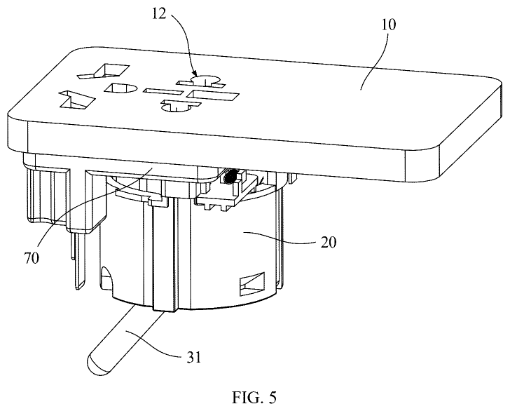

Referring to FIG. 5, in some examples of the present disclosure, the adapter hole 12 and the opening 11 are provided on two opposite sides of the housing 10, the lifting platform 20 has a mounting chamber, the plug 1 further includes a jack module 70, the jack module 70 has a slot in communication with the adapter hole 12, the slot is used for insertion of pins of another plug, and the user can insert the pins of the electric equipment into the slot through the adapter hole 12 to supply power to the electric equipment through the plug 1. The jack module 70 may be used to hold and clamp the pin of the plug when the plug is inserted into the adapter hole 12, and that the jack module 70 is located inside the housing 10.

When the lifting platform 20 is located in the accommodating chamber, the jack module 70 may be entirely located in the mounting chamber, or a part of the jack module 70 may be located in the mounting chamber. When the lifting platform 20 projects out of the accommodating chamber, the jack module 70 is located in the accommodating chamber, so that space in the lifting platform 20 can be fully utilized, and a space utilization rate in the housing 10 is improved. In this way, the space occupied by the plug 1 during storage is reduced, which is convenient for the user to carry.

Referring to FIGS. 4 to 7, in some examples of the present disclosure, the plug 1 further includes a control circuit board and a conductive member 21 (e.g., metal contact plate, pin, strip, wire). The control circuit board is disposed on the housing 10, and the conductive member 21 is disposed on the lifting platform 20 and electrically connected to the control circuit board. The control circuit board is electrically connected to an external power supply, and can transfer a current of the external power supply to the conductive member 21.

A tail end of the first pin 31 is provided with a power connection portion 311. When the first pin 31 is at the unfolded position, the power connection portion 311 is electrically connected to the conductive member 21, so that the current on the conductive member 21 can be transferred to the power connection portion 311 and the first pin 31. When the first pin 31 is at the stored position, the power connection portion 311 is separated from the conductive member 21, thereby ensuring cutoff safety of the first pin 31.

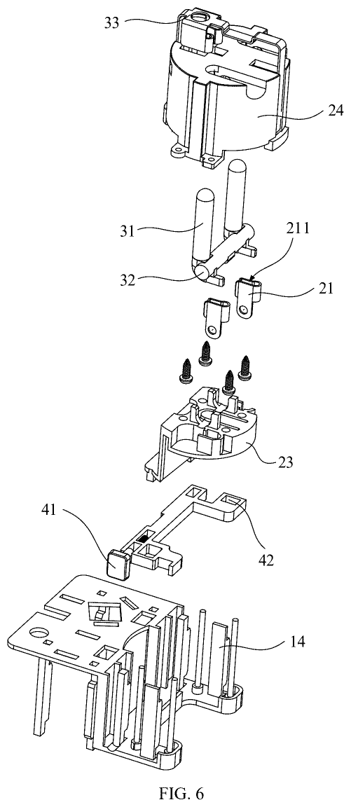

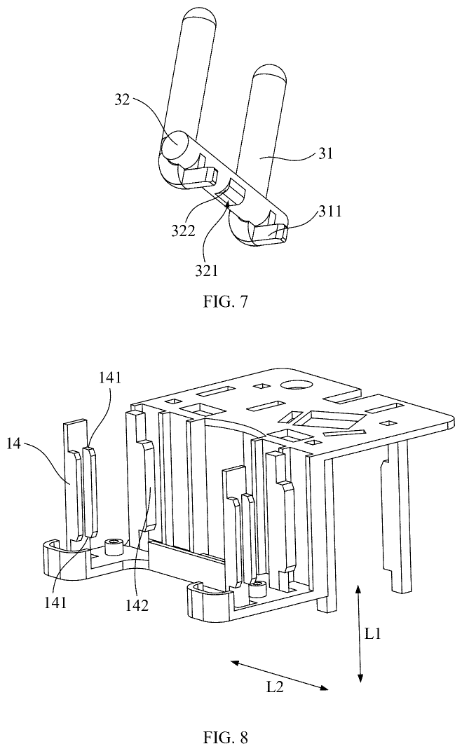

Further, referring to FIGS. 6 and 7, in some examples of the present disclosure, the conductive member 21 has a sandwich slot disposed on a side facing the power connection portion 311. When the first pin 31 is rotated from the stored position to the unfolded position, the first pin 31 drives the power connection portion 311 to rotate and enter the sandwich slot, and the power connection portion 311 is in clamping connection with the sandwich slot, thus ensuring stable contact between the first pin 31 and the conductive member 21 and reducing shaking of the first pin 31.

Further, still referring to FIGS. 6 and 7, in some examples of the present disclosure, the first pin assembly 30 further includes a rotating shaft 32, the first pin 31 is rotatably connected to the lifting platform 20 through the rotating shaft 32, and the rotating shaft 32 has an abutting plane 321 on a peripheral side thereof. When the first pin 31 is rotated to the unfolded position, the abutting plane 321 abuts against the lifting platform 20 (e.g., the abutting plane 321 on the peripheral side of the rotating shaft 32 abuts against a surface of the lifting platform 20), so as to reduce unstable shaking of the first pin 31 at the unfolded position.

In some examples, as shown in FIG. 7, the rotating shaft 32 is provided with a protrusion 322 on a circumferential side thereof, the protrusion 322 has a first surface and a second surface that are adjacent to each other, and both the first surface and the second surface may abut against the lifting platform 20. Both the first surface and the second surface are abutting planes 321, and the protrusion 322 is formed by the two abutting planes 321. When the first pin 31 is rotated to the unfolded position, the first surface abuts against the lifting platform 20, and when the first pin 31 is rotated to the stored position, the second surface abuts against the lifting platform 20, thereby increasing stability of the first pin 31 at any position. Meanwhile, the first surface and the second surface are connected through an arc surface to reduce friction between the rotating shaft 32 and the lifting platform 20, thus facilitating a user to push the rotating shaft 32 to rotate.

Referring to FIG. 8, in some examples of the present disclosure, the housing 10 includes a limiting bracket 14 disposed in the accommodating chamber. An extension direction of the limiting bracket 14 is parallel to the axial direction of the opening 11, both ends of the limiting bracket 14 are provided with limiting portions 141. Both ends of the limiting bracket 14 along a first direction L1 are provided with the limiting portions 141, and the first direction LI is parallel to the axial direction of the opening 11. The limiting bracket 14 includes a sliding portion 142, and the sliding portion 142 is located between the limiting portions 141 at the both ends.

As shown in FIG. 6, the lifting platform 20 includes a main body 24 and a base 23 connected to each other, and the first pin assembly 30 and the base 23 are disposed on two opposite sides of the main body 24. As shown in FIGS. 8 to 10, the plug 1 further includes a locking member 42 (e.g., locking device, sliding latch, a locking pin) connected to the base 23, the locking member 42 is movably connected to the housing 10 and the sliding portion 142 of the limiting bracket 14, and when the locking member 42 moves relative to the sliding portion 142 along the first direction L1, the locking member 42 can drive the entire lifting platform 20 to move along the first direction L1. Meanwhile, the locking member 42 may also be connected to the limiting portions 141 of the limiting bracket 14, and when the locking member 42 moves from the sliding portion 142 to the limiting portions 141, the locking member 42 abuts against the limiting portions 141 and the locking member 42 is in a locked state with the limiting bracket 14.

Specifically, for example, two ends of the sliding portion 142 are respectively a first limiting step and a second limiting step. When the locking member 42 abuts against the first limiting step, the lifting platform 20 is locked in the accommodating chamber, and when the locking member abuts against the second limiting step, the lifting platform 20 is locked outside the accommodating chamber.

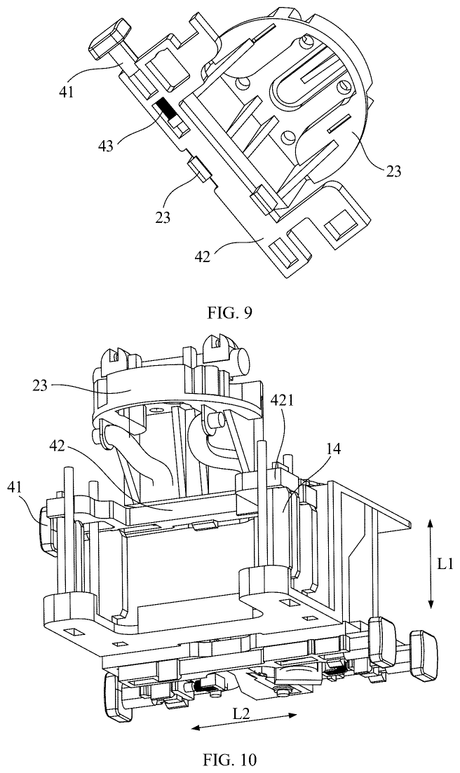

For example, as shown in FIG. 8, which is a schematic view showing a structure of the limiting bracket 14, the sliding portion 142 and the limiting portion 141 have a height difference in a second direction L2, and the second direction L2 is perpendicular to the first direction L1. As shown in FIGS. 9 and 10, FIG. 9 is a schematic view showing an installation structure of the locking member 42 and the base 23, and FIG. 10 is mainly a schematic view showing installation of the limiting bracket 14, the locking member 42, and the base 23.

The locking member 42 may be moved on the sliding portion 142 along the first direction L1, and when the locking member 42 is moved to the end of the sliding portion 142, the locking member 42 may be moved to the limiting portion 141 along the second direction L2. Since the limiting portion 141 and the sliding portion 142 have a height difference in the second direction L2, the limiting portion 141 blocks the locking member 42 from continuously sliding along the first direction L1. In this way, the limiting portion 141 locks the locking member 42. Similarly, when the locking of the locking member 42 needs to be released, an acting force can be applied to the locking member 42 in the second direction L2 to move the locking member 42 relative to the limiting portion 141 in the second direction L2, thereby releasing the locking between the locking member 42 and the limiting portion 141. It can be understood that the locking member 42 is movably connected to the housing 10 along the first direction L1 and the second direction L2, for example, the locking member 42 may be first moved along the second direction L2 to release the locking with the limiting portion 141, and then the locking member 42 may be moved on the sliding portion 142 along the first direction L1 to drive the lifting platform 20 to enter and exit the accommodating chamber.

Further, referring to FIG. 9, in some examples of the present disclosure, the plug 1 further includes an elastic member 43 (e.g., a spring, a band) extending along the second direction L2, one end of the elastic member 43 is connected to the locking member 42, the other end of the elastic member 43 is connected to the base 23 of the lifting platform 20, and the elastic member 43 is used to reset the locking member 42 along the second direction L2.

Specifically, during the sliding of the lifting platform 20 from the inside to the outside of the accommodating chamber, the locking member 42 first abuts against the first limiting step, and then an external force along the second direction L2 is applied to the locking member 42. At this time, the elastic member 43 receives an acting force from the locking member 42, the elastic member 43 is in a deformed state, and the locking member 42 is moved along the second direction L2 to release the locking with the limiting portion 141. Subsequently, an external force along the first direction L1 is applied to the locking member 42, so that the locking member 42 slides on the sliding portion 142 along the first direction L1, until the locking member 42 slides to the end of the sliding portion 142 along the first direction L1. At this time, no force or reduced force is applied to the elastic member 43, the elastic member 43 can drive the locking member 42 to move along the second direction L2 and abut against the second limiting step, thus locking the locking member 42 with the limiting portion 141.

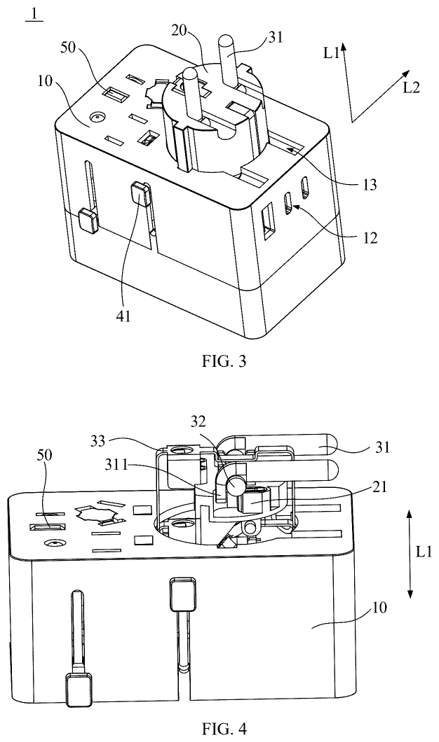

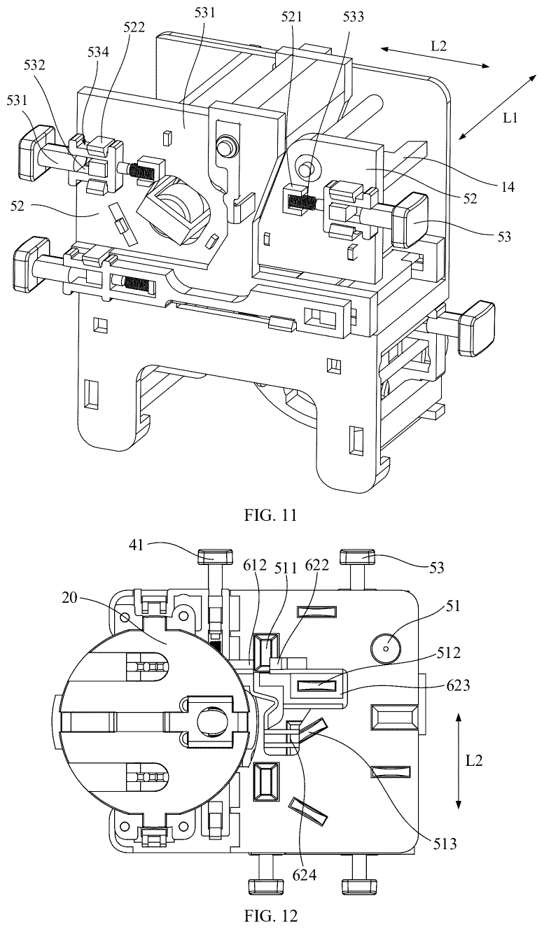

Referring to FIGS. 11 and 12, in some examples of the present disclosure, the plug 1 further includes a plurality of second pin assemblies 50 (as shown in FIGS. 3 and 4) in the housing 10, each of the second pin assemblies 50 includes a plurality of second pins 51, the second pins 51 can move (e.g., slide) relative to the housing 10 along the first direction LI to enter and exit the accommodating chamber, and the first direction L1 is parallel to the axial direction of the opening 11. The plurality of second pin assemblies 50 may comprise a plurality of groups of pins.

For example, as shown in FIG. 12, a plurality of the second pin assemblies 50 includes a UK-standard pin assembly, a US-standard pin assembly, and a Chinese-standard pin assembly. The UK-standard pin assembly includes three UK-standard pins 511 (e.g., a group of the second pins 51), the US-standard pin assembly includes three US-standard pins 512 (e.g., a group of the second pins 51), and the Chinese-standard pin assembly includes three Chinese-standard pins 513 (e.g., a group of the second pins 51). Specifically, the three second pin assemblies 50 are all located on one side of the lifting platform 20, and arrangement positions of grounding pins in the three second pin assemblies 50 are located on the same straight line at intervals. The US-standard pin assembly and the Chinese-standard pin assembly are arranged in parallel at intervals, and the live wire pin and the neutral wire pin in the UK-standard pin assembly are respectively located among the US-standard pin assembly and the Chinese-standard pin assembly, thereby not only meeting safety requirements of the UK-standard plug, but also ensuring safety requirements of either of the US-standard pin 512 and the Chinese-standard pin 513 to an edge of the housing.

The number of the limiting brackets 14 can be set in one-to-one correspondence with the number of the first pin assemblies 30 and the number of the second pin assemblies 50. In some examples, as shown in FIG. 11, each of the second pin assemblies 50 further includes a bearing plate 52 and a button 53. The button 53 includes a button main body 531 and a lock catch 532 connected to each other. A plurality of the second pins 51 are all fixed to the bearing plate 52, the button main body 531 is movably connected to the bearing plate 52 along the second direction L2 (e.g., in a sliding manner), the lock catch 532 of the button 53 is movably connected to one limiting bracket 14, and the lock catch 532 is used to lock or unlock the limiting portion 141.

Meanwhile, as shown in FIG. 11, each of the second pin assemblies 50 further includes a spring 533, the bearing plate 52 includes a fixing portion 521, and the spring 533 is disposed between the button main body 531 and the fixing portion 521 and extends along the second direction L2. When a plurality of the second pins 51 are located in the accommodating chamber, and the lock catch 532 is locked with the limiting portion 141 of the limiting bracket 14, an external force is applied to the button main body 531 along the second direction L2, the button main body 531 first compress the spring 533, and the button 53 slides relative to the bearing plate 52 along the second direction L2. At this time, the lock catch 532 is unlocked with the limiting portion 141 of the limiting bracket 14, the button main body 531 drives the bearing plate 52 and the second pins 51 to slide relative to the limiting bracket 14 along the first direction L1, and thus a plurality of the second pins 51 are pushed out of the accommodating chamber along the first direction L1. After the external force disappears, the button main body 531 is moved along the second direction L2 under the action of an elastic force of the spring 533, and thus the lock catch 532 is locked with the limiting portion 141 of the limiting bracket 14 again, so as to fix the second pins 51 outside the accommodating chamber. The button main body 531 may be provided with a sliding groove 534 extending along the second direction L2, the bearing plate 52 may further include a sliding block 522, the sliding groove 534 and the sliding block 522 are movably connected along the second direction L2 (e.g., in a sliding manner), and the sliding groove 534 defines a movable track path for the button main body 531 along the second direction L2, thereby preventing a sliding distance of the button 53 relative to the bearing plate 52 from being too large or too small.

Further, referring to FIGS. 12-16, in some examples of the present disclosure, the housing 10 includes a first side portion (e.g., a first side), and the opening 11 is located on the first side portion. The plug 1 further includes a limiting structure 60 disposed on the first side portion. The limiting structure 60 can be configured to slide relative to the housing 10 along the second direction L2, and is configured to block the lifting platform 20 or the second pins 51 from projecting out of the accommodating chamber along the first direction L1. The second direction L2 is perpendicular to the first direction L1.

When the lifting platform 20 projects out of the accommodating chamber, the limiting structure 60 blocks the second pins 51 in a plurality of the second pin assemblies 50 from projecting out of the accommodating chamber, and when one of a plurality of the second pins 51 projects out of the accommodating chamber, the limiting structure 60 blocks the lifting platform 20 and other of the second pins 51 from projecting out of the accommodating chamber. For example, a plurality of the second pins 51 include the UK-standard pins 511, the US-standard pins 512, and the Chinese-standard pins 513. When any one of the lifting platform 20, the UK-standard pins 511, the US-standard pins 512, and the Chinese-standard pins 513 projects out of the accommodating chamber, the limiting structure 60 slides to a position that blocks the other three from projecting out of the accommodating chamber. At this time, the other three do not project out of the accommodating chamber even if pushed again, so that the limiting structure 60 locks and limits the other three pins or the lifting platform 20.

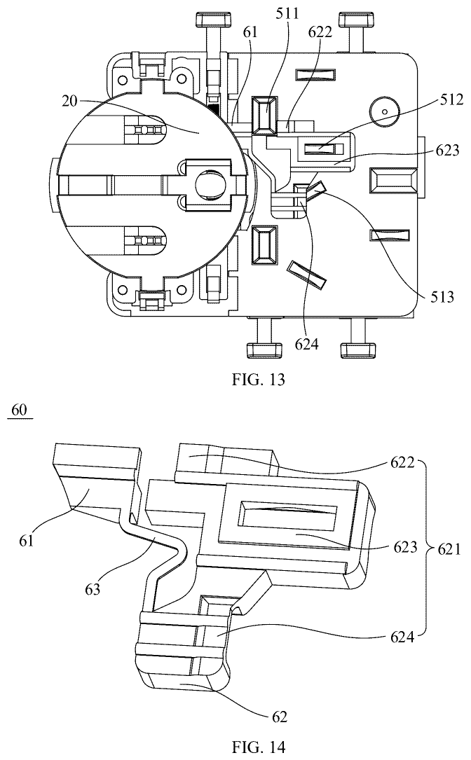

Further, referring to FIGS. 13 and 14, in some examples of the present disclosure, the lifting platform 20 is provided with, on a side wall thereof, a limiting groove 22 (as shown in FIG. 2). The limiting structure 60 includes a first portion 61 and a second portion 62, when the lifting platform 20 projects out of the accommodating chamber, the first portion 61 blocks one of the second pins 51 adjacent to the lifting platform 20 from projecting out of the accommodating chamber, and when the lifting platform 20 does not project out of the accommodating chamber, the first portion 61 enters the limiting groove 22 to block the lifting platform 20.

The second portion 62 and the first portion 61 are connected by an elastic arm 63, the second portion 62 and the first portion 61 are spaced apart, the lifting platform 20 is located on a side of the first portion 61 away from the second portion 62, one of the second pins 51 is located between the first portion 61 and the second portion 62, and other of the second pins 51 are located on a side of the second portion 62 away from the first portion 61. When part of the second pins 51 project out of the accommodating chamber, the first portion 61 enters the limiting groove 22 to block the lifting platform 20, and the second portion 62 blocks the other part of the second pins 51 from projecting out of the accommodating chamber.

Specifically, when the second pin 51 (e.g., pins 511) located between the first portion 61 and the second portion 62 projects out of the accommodating chamber (as shown in FIG. 13), the second pin 51 can push the first portion 61 to move and enter the limiting groove 22, and the second pin 51 can also push the second portion 62 to move to block other of the second pins 51. When one of the second pins 51 located on a side of the second portion 62 away from the first portion 61 projects out of the accommodating chamber, the second pin 51 can push the limiting structure 60 to move to block the lifting platform 20 and other of the second pins 51.

For example, as shown in FIGS. 12 and 13, the second pin assembly 50 includes a UK-standard pin assembly, a US-standard pin assembly, and a Chinese-standard pin assembly, a plurality of the second pins 51 include the UK-standard pin 511, the US-standard pin 512, and the Chinese-standard pin 513, the first portion 61 includes a first region 612 away from the lifting platform 20, the second portion 62 includes a second region 622, a third region 623, and a fourth region 624. When the lifting platform 20 projects out of the accommodating chamber, a side wall of the lifting platform 20 pushes the first portion 61 to slide in a direction approaching the second portion 62, the first region 612 of the first portion 61 slides to a position that blocks the UK-standard pin 511, the third region 623 of the second portion 62 slides to a position that blocks the US-standard pin 512, and the fourth region 624 slides to a position that blocks the Chinese-standard pin 513. When the UK-standard pin 511 projects out of the accommodating chamber, the first portion 61 enters the limiting groove 22 to block the lifting platform 20, the third region 623 slides to a position that blocks the US-standard pin 512, and the fourth region 624 slides to a position that blocks the Chinese-standard pin 513. When the US-standard pin 512 projects out of the accommodating chamber, the first portion 61 enters the limiting groove 22 to block the lifting platform 20, the second region 622 slides to a position that blocks the UK-standard pin 511, and the fourth region 624 slides to a position that blocks the Chinese-standard pin 513. When the Chinese-standard pin 513 projects out of the accommodating chamber, the first portion 61 enters the limiting groove 22 to block the lifting platform 20, the second region 622 slides to a position that blocks the UK-standard pin 511, and the third region 623 slides to a position that blocks the US-standard pin 512.

In some examples, any one of the second region 622, the third region 623, and the fourth region 624 in the second portion 62 may include a limiting hole, the limiting hole allows one of the second pins 51 to project out of the accommodating chamber, that is, when one of the second pins 51 disposed corresponding to the limiting hole projects out of the accommodating chamber, the second pin 51 can pass through the limiting hole, and thus the position of the second portion 62 is fixed, and other of the second pins 51 are blocked by other regions of the second portion 62.

For example, when a distance of the first portion 61 entering the limiting groove 22 is set as A1, and a distance between the first portion 61 and the second portion 62 is set as A2, A1>A2. When the lifting platform 20 projects out of the accommodating chamber, the side wall of the lifting platform 20 pushes the first portion 61 to slide in a direction approaching the second portion 62, so that the first region 612 of the first portion 61 can block the UK-standard pin 511, and the movement of the first portion 61 also drives the second portion 62 to move in the same direction, so that the second portion 62 blocks the US-standard pin 512 and the Chinese-standard pin 513.

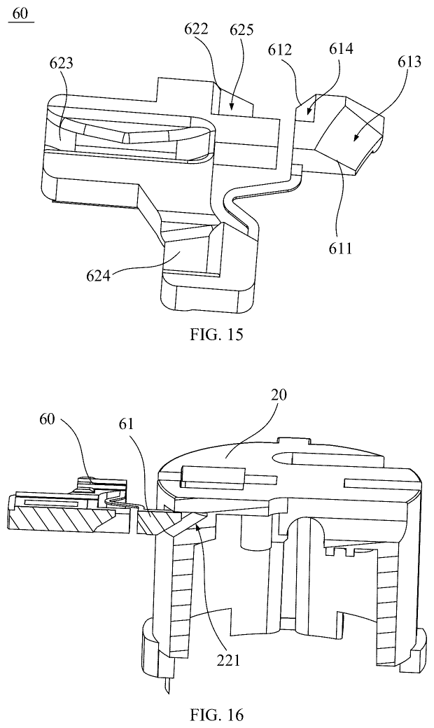

Further, referring to FIGS. 15 and 16, in some examples of the present disclosure, the limiting groove 22 has a bevel groove wall 221, and the first portion 61 has a first bevel 613 corresponding to the bevel groove wall 221. When the first portion 61 enters the limiting groove 22, the first bevel 613 contacts the bevel groove wall 221, and both the first bevel 613 and the bevel groove wall 221 can play a guiding role to facilitate the first portion 61 to enter and exit the limiting groove 22.

Additionally or alternatively, in some examples, the first portion 61 has, on a side thereof away from the lifting platform 20, a second bevel 614, the second bevel 614 is configured to contact a head end of the second pin 51, the second portion 62 has a third bevel 625, the third bevel 625 is configured to contact the head end of the second pin 51, and both the second bevel 614 and the third bevel 625 can play a guiding role to facilitate the second pin 51 to project out of the accommodating chamber by pushing the first portion 61 or the second portion 62.

Additionally or alternatively, in some examples, the head end of the second pin 51 has a guiding bevel configured to contact the first portion 61 and the second portion 62, thus facilitating the second pin 51 to project out of the accommodating chamber by pushing the first portion 61 or the second portion 62.

The same or similar reference numerals in the drawings of the examples of the present disclosure correspond to the same or similar parts. In the description of the present disclosure, it is to be understood that the terms “upper”, “lower”, “left”, “right”, and the like indicating relationships of directions and positions are based on relationships of directions and positions shown in the drawings, and are intended to be illustrative and simplify descriptions only and not to indicate or imply that the referred assembly or element must be provided in a particular direction, configured and operated in a particular direction. Therefore, the terms used to describe relationships of positions are intended to be illustrative only and are not intended to limit the present disclosure. The term “disposed on” may mean that an object is placed on the surface of another object or in another object. For those skilled in the art, specific meanings of the above terms can be understood according to specific situations.

The above are only preferred examples of the present disclosure and are not intended to limit the disclosure. Any modifications, equivalent substitutions, improvements or the like within the spirit and principle of the disclosure should be within the scope of the disclosure.

What is claimed is:

1. A plug comprising:
a housing having an accommodating chamber, an opening in communication with the accommodating chamber, and an adapter hole;
a lifting platform configured to slide in an axial direction of the opening relative to the housing; and
a plurality of pins pivotably connected to the lifting platform, wherein:
the plurality of pins are configured to switch between an unfolded position and a stored position,
the plurality of pins are folded in storage grooves in the stored position, and
the plurality of pins extend along the axial direction of the opening in the unfolded position.

2. The plug of claim 1, wherein an end of each of the plurality of pins is located outside the storage grooves.

3. The plug of claim 1, wherein:
the adapter hole and the opening are provided on two opposite sides of the housing, and
the lifting platform has a mounting chamber.

4. The plug of claim 1, further comprising:
a control circuit board in the housing; and
a conductive plate in the lifting platform and electrically connected to the control circuit board, wherein:
when one of the plurality of pins is at the stored position, an end of the one of the plurality of pins is separated from the conductive plate, and
when the one of the plurality of pins is at the unfolded position, the end of the one of the plurality of pins is electrically connected to the conductive plate.

5. The plug of claim 4, wherein:
the conductive plate has a sandwich slot disposed on a side facing the end of the one of the plurality of the pins, and
when the one of the plurality of the pins is switched from the stored position to the unfolded position, the end of the one of the plurality of the pins is clamped into the sandwich slot.

6. The plug of claim 1, further comprising a rotating shaft, wherein one of the plurality of the pins is pivotably connected to the lifting platform through the rotating shaft.

7. The plug of claim 6, wherein when the one of the plurality of the pins is switched to the unfolded position, the rotating shaft abuts against the lifting platform.

8. The plug of claim 1, wherein the housing comprises a limiting bracket in the accommodating chamber, and the plug further comprises:
a locking device movably connected to the lifting platform, the housing, and the limiting bracket, and configured to lock and unlock the limiting bracket, wherein:
when the locking device is locked with a portion of the limiting bracket, the lifting platform is locked, and when the locking device is unlocked with the portion of the limiting bracket, the locking device is configured to drive the lifting platform to slide along an extension direction of the limiting bracket.

9. The plug of claim 1, further comprising a plurality of second pins configured to move relative to the housing along a first direction parallel to the axial direction of the opening.

10. The plug of claim 9, wherein:
the housing comprises a first side, and the opening is located on the first side, and
the plug further comprises a limiting structure disposed on the first side and configured to slide relative to the housing along a second direction perpendicular to the first direction, and block a portion of the lifting platform or the plurality of second pins from projecting out of the accommodating chamber along the first direction.

11. The plug of claim 10, wherein:
in response to the lifting platform projecting out of the accommodating chamber, the limiting structure blocks each of the plurality of second pins from projecting out of the accommodating chamber, and
in response to the plurality of second pins projecting out of the accommodating chamber along the first direction, the limiting structure blocks the lifting platform and other pins from projecting out of the accommodating chamber.

12. The plug of claim 10, wherein the lifting platform comprises a limiting groove, and the limiting structure comprises:
a first portion configured to enter the limiting groove to block the lifting platform or the plurality of second pins,
a second portion connected with the first portion by an elastic arm and spaced apart from the first portion,
the lifting platform is located on a side of the first portion away from the second portion, and the plurality of second pins is located between the first portion and the second portion,
in response to the lifting platform projecting out of the accommodating chamber, the first portion blocks one of the plurality of second pins, and the second portion blocks another one of the plurality of second pins, and
in response to the one of the plurality of second pins projecting out of the accommodating chamber, the first portion enters the limiting groove to block the lifting platform, and the second portion blocks the another one of the plurality of the second pins.

13. The plug of claim 12, wherein:
the limiting groove has a bevel groove wall, the first portion has a first bevel corresponding to the bevel groove wall, and when the first portion enters the limiting groove, the first bevel contacts the bevel groove wall, and
the first portion has, on a side away from the lifting platform, a second bevel configured to contact an end of the one of the plurality of second pins, and the second portion has a third bevel configured to contact the end of the one of the plurality of second pins.

14. A plug comprising:
a housing comprising an opening;
a body, wherein at least a portion of the body is configured to pass the opening; and
a plurality of pins pivotably connected to the body, wherein:
the plurality of pins are configured to switch between an unfolded position and a stored position,
the plurality of pins are folded in storage grooves of the body in the stored position, and
the plurality of pins extend along an axial direction of the opening in the unfolded position.

15. The plug of claim 14, wherein an end of each of the plurality of pins is located outside the storage grooves.

16. The plug of claim 14, further comprising:
a slot configured for insertion of pins of another plug.

17. The plug of claim 14, wherein:
the body comprise a conductive plate in the body,
when one of the plurality of pins is at the stored position, an end of the one of the plurality of pins is separated from the conductive plate, and
when the one of the plurality of pins is at the unfolded position, the end of the one of the plurality of pins is electrically connected to the conductive plate.

18. The plug of claim 17, wherein:
the conductive plate has a sandwich slot disposed on a side facing the end of the one of the plurality of the pins, and
when the one of the plurality of the pins is switched from the stored position to the unfolded position, the end of the one of the plurality of the pins is clamped into the sandwich slot.

19. The plug of claim 14, further comprising a rotating shaft, wherein one of the plurality of the pins is pivotably connected to the body through the rotating shaft.

20. The plug of claim 14, further comprising a plurality of second pins configured to move relative to the housing along a first direction parallel to the axial direction of the opening.
